(19) United States
(12) Patent Application Publication
(10) Pub. No.: US 2017/0017119 A1
(43) Pub. Date: Jan. 19, 2017

(54) BACKLIGHT MODULE FOR LCD DEVICE

(71) Applicant: HON HAI PRECISION INDUSTRY CO., LTD., New Taipei (TW)

(72) Inventor: CHENG-WEI LEE, New Taipei (TW)

(21) Appl. No.: 14/824,716

(22) Filed: Aug. 12, 2015

(30) Foreign Application Priority Data
Jul. 15, 2015 (TW) 104122848

(51) Int. Cl. G02F 1/1335; F21V 8/00; G02F 1/1333

(52) U.S. Cl. CPC G02F 1/133603; G02F 1/133308; G02F 1/133605; G02F 1/133606; G02F 1/133528; G02F 1/133553; G02F 1/133524; G02B 6/0031; G02F 2001/133317

(57) ABSTRACT

A backlight module for an LCD device includes a front module and a rear module. The front module includes a middle frame and a plurality of optical films coupled to the middle frame. The rear module includes a rear shell, an optical plate and a light emitting source. The rear module is connected to the front module by having the middle frame and the rear shell mechanically connected together. The backlight module can be a vertical type or an edge type backlight module by having the front module coupled with the rear module having a required structure.

### CROSS-REFERENCE TO RELATED APPLICATIONS

This application claims priority to Taiwan Patent Application No. 104122848 filed on Jul. 15, 2015, the contents of which are incorporated by reference herein.

### FIELD

The subject matter herein generally relates to a backlight module, and particularly to a backlight module for a liquid crystal display (LCD) device, which can be adapted to an edge lighting or a vertical lighting in a low cost manner.

### BACKGROUND

An LCD is not self-illuminating and needs a backlight module to provide illumination, so that the LCD can attain its display function. An LCD device includes the LCD and the backlight module. Generally, a backlight module is 30-50% of the cost of the LCD device.

A backlight module generally consists of a light source, a light guide or a diffusion plate, optical films and a plastic frame. According to the position of the light source, the backlight module can be classified into two types: a vertical type where the light source is located behind the diffusion plate and an edge type wherein the light source is located at edges of the light guide. The components for producing the vertical type and edge type backlight modules cannot be exchanged, whereby the cost for the backlight module cannot be lowered.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is perspective view of an LCD device including a backlight module in accordance with an embodiment of the present disclosure.

FIG. 2 is an exploded view of the LCD device of FIG. 1.

FIG. 3 is a view similar to FIG. 2, viewed from another angle.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

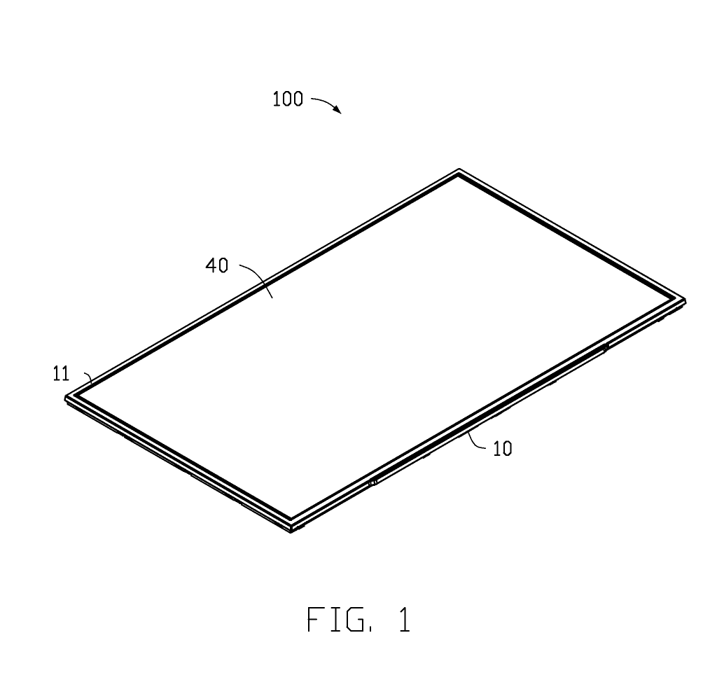

FIG. 1 illustrates an LCD device 100 which includes a backlight module in accordance with the present disclosure. Additionally the LCD device 100 includes a display panel 40 and a frame assembly 11 surrounding the display panel 40. The frame assembly 11 can be made of plastic, while the display panel 40 can be made of glass.

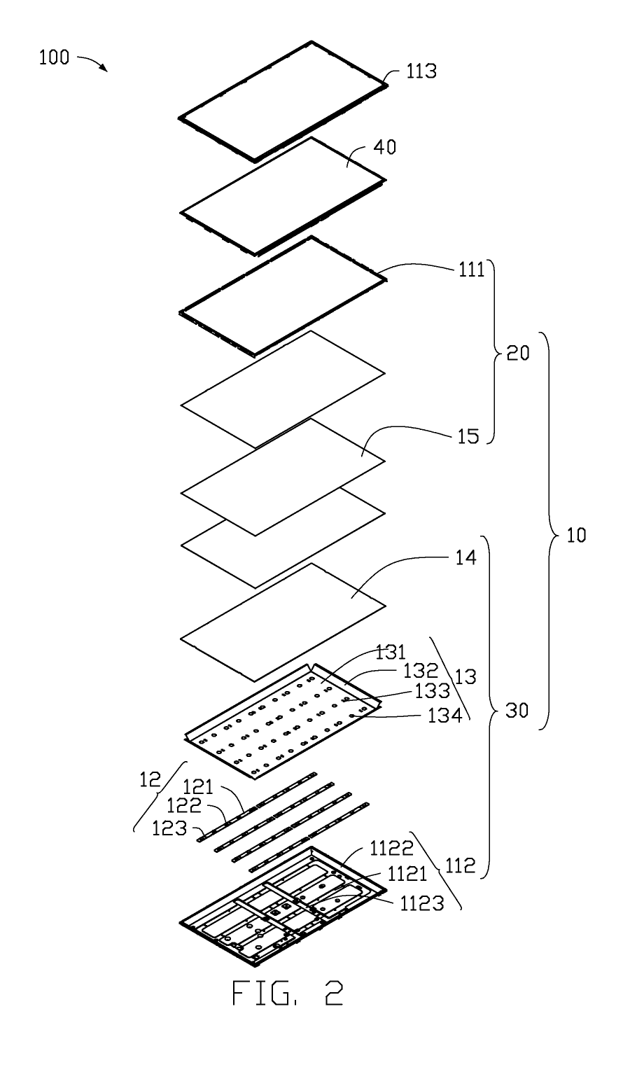

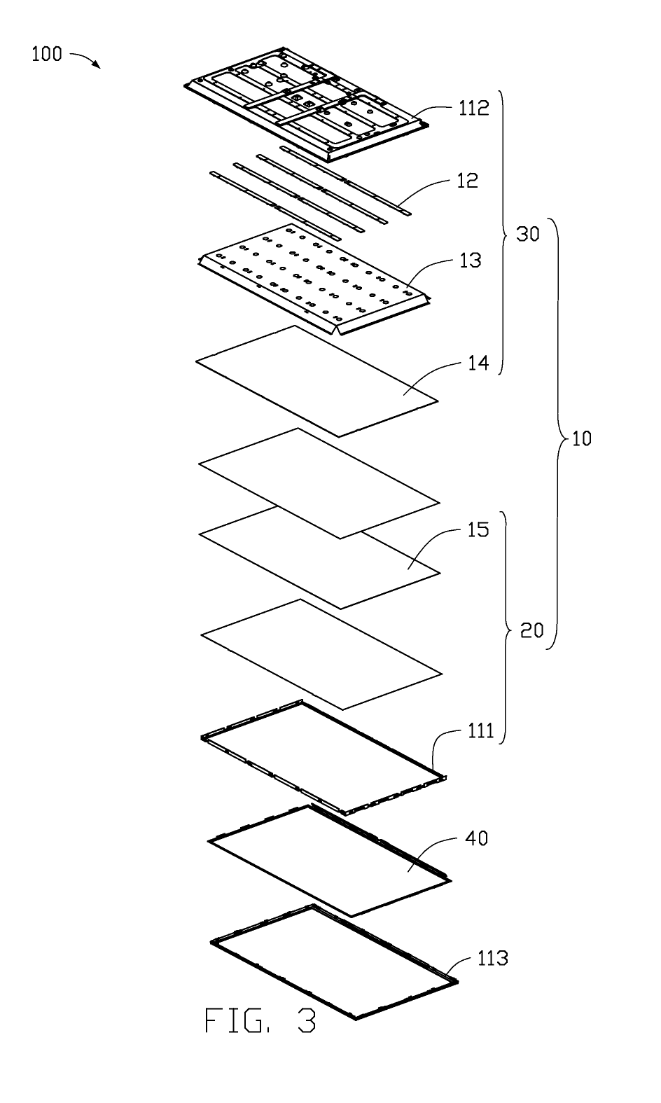

FIGS. 2 and 3 illustrate that a backlight module 10 of the LCD device 100 includes a light emitting unit 12, a reflective plate 13, an optical plate 14 and a plurality of optical films 15. The frame assembly 11 includes a middle frame 111 and a rear shell 112. The backlight module 10 includes a front module 20 and a rear module 30. The optical films 15 are coupled to the middle frame 111 to constitute the front module 20. The light emitting unit 12, the reflective plate 13 and the optical plate 14, which can be a diffusion plate in the illustrated embodiment, are coupled to the rear shell 112 to constitute the rear module 30.

The front module 20 is a common module which can be used in different types of backlight module (for example, a vertical type and an edge type). The structure of the front module 20 does not need any modification whether it is used in a vertical type backlight module or an edge type backlight module. The rear module 30 is a specially designated module which can be used in only one type of backlight module. In the illustrated embodiment, the backlight module 10 having the rear module 30 is a vertical type backlight module. When the backlight module 10 is required to be an edge type backlight module, the structure of the rear module 30 is modified. For example, the positional and connection relationships between the optical plate 14 and the light emitting unit 12 can be modified to meet the requirement of an edge type backlight module. The front module 20 and the rear module 30 can be connected together through a mechanical connection such as a screwing connection or a snapping connection.

In accordance with the shown embodiment, the backlight module 10 includes the front module 20 and the rear module 30 which is specifically designed for a vertical type backlight module. It can be understood that in another embodiment, the backlight module 10 can be an edge type backlight module for which the front module 20 is unchanged while the rear module 30 has a different structure.

The rear shell 112 of the rear module 30, in accordance with the illustrated embodiment, is substantially rectangular in shape and includes a base plate 1121 and a sidewall 1122 projecting upwardly and outwardly from four sides of the base plate 1121. The base plate 1121 and the side plate 1122 cooperatively define a chamber 1123 therebetween. The chamber 1123 opens toward the middle frame 111. The chamber 1123 is provided for accommodating therein the light emitting unit 12 and the reflective plate 13. The rear shell 112 can be coupled to a fixture (not shown) such as a rear cover of the LCD device 100 by attaching a rear face of the base plate 1121 thereto.

In the illustrated embodiment, the light emitting unit 12 together with the reflective plate 13 is secured to the base plate 1121 of the rear shell 112 and received in the chamber 1123. The light emitting unit 12 is positioned between the base plate 1121 of the rear shell 112 and the reflective plate 13. In another embodiment, the light emitting unit 12 can be positioned over the reflective plate 13, whereby the reflective plate 13 is positioned between the light emitting unit 12 and the base plate 1121 of the rear shell 112. The light emitting unit 12 includes a plurality of light bars 121 each having an elongated substrate defining a plurality of holes 123 therethrough and mounted with a plurality of light emitting diodes (LEDs) 122 thereon. Screws (not shown) are used to extend through the holes 123 to engage in the base plate 1121 to thereby secure the light bars 121 to the base plate 1121. The light bars 121 are arranged in an array in the rear shell 112.

The reflective plate 13 is substantially rectangular in shape and has a dimension slightly smaller than a dimension of the chamber 1123 of the rear shell 112. Like the rear shell 112, the reflective plate 13 also has a base plate 131 and a sidewall 132 projecting upwardly and outwardly from four sides of the base plate 131. The base plate 131 and the sidewall 132 both are light reflective. The reflective plate 13 is received in the chamber 1123. The base plate 131 of the reflective plate 13 defines a plurality of fixing holes 133 and a plurality of through holes 134 therethroug.h. The fixing holes 133 are positioned corresponding to the holes 123 in the substrates of the light bars 121 whereby the screws (not shown) can first extend through the fixing holes 133 of the reflective plate 13 and then the holes 123 of the light bars 121 to simultaneously secure the light bars 121 and the reflective shell 13 to the base plate 1121of the rear shell 112. The through holes 134 of the reflective plate 3 are located corresponding to the LEDs 122, whereby when the light bars 121 and the reflective plate 13 are assembled together, the LEDs 122 extend through the through holes 134 to be located above the base plate 131 of the reflective plate 13. Light generated by the LEDs 122 is reflected by the reflective plate 13 to move upwardly toward the optical plate 14. In the rear module 30 of an edge type backlight module, the reflective plate 13 can be omitted.

The optical plate 14 is a substantially flat and rectangular plate, which has a dimension slightly larger than an opening of the chamber 1123 of the rear shell 112. The optical plate 14 is secured to the sidewall 1122 of the rear shell 112.The optical plate 14 can be a diffusion plate. In another embodiment, for example, in an edge type backlight module, the optical plate 14 of the rear module 30 can be a light guide, wherein the light bars 121 are positioned near the four side edges of the optical plate 14.

In assembling the rear module 30, first the light emitting unit 12 and the reflective plate 13 are sequentially put on the base plate 1123 of the rear shell 112, in which the LEDs 122 extend thorough the through holes 134 of the reflective plate 13 to be exposed from the reflective plate 13. Then, the screws (not shown) are used to extend through the fixing holes 133 of the reflective plate 13 and the holes 123 of the light bars 121; the screws thereafter engage in the base plate 1123 of the rear shell 112 to secure the reflective plate 13 and the light bars 121 thereto. The light emitting unit 12 and the reflective plate 13 are accommodated in the chamber 1123 of the rear shell 112. Then, the optical plate 14 is securely mounted on the sidewall 1122 of the rear shell 112.

The middle frame 111 has a configuration of a hollow rectangle. The optical films 15 each are rectangle and have a dimension slightly larger than a void defined by the middle frame 111. The optical films 15 are secured to a side of the middle frame 111 facing the rear shell 112. The optical films 15 are used to collect the light emitted from the optical plate 14, uniformly mix the light and direct the light at desired angles after it leaves the optical films 15. The front module 20 includes three optical films 15 which can be the same to or different from each other. The optical films 15 can include prism films, reflective polarization films, or etc.

In assembling the backlight module 10, the middle frame 111 is brought to be secured to the sidewall 1122 of the rear shell 112, thereby connecting the front module 20 and the rear module 30 together.

In accordance with the present disclosure, the backlight module 10 is divided into the front module 20 and the rear module 30 wherein the front module 20 is a common module which can couple with the rear module 30 which can have an edge type light source or a vertical type light source as disclosed in the shown embodiment. By such design, the edge type backlight module and the vertical type backlight module can share the common front module 20 to lower the manufacturing cost for the backlight module 10.

When the backlight module 10 is used in the LCD device 100, the display panel 40 is secured to a side of the middle frame 1 1 l opposite the rear shell 112. The backlight module 10 provides a planar light source for the display panel 40. The frame assembly 11 can further include a front frame 113 which is coupled to a side of the middle frame 111 opposite the rear shell 112 whereby the middle frame 111 is located between the front frame 113 and the rear shell 112. The display panel 40 is sandwiched between the front frame 113 and the middle frame 111.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. A backlight module comprising:
a front module comprising a hollow middle frame and at least one optical film attached to the middle frame;
a rear module comprising a rear shell to which the middle frame is mechanically connected;
an optical plate received in the rear shell; and
a light emitting source for generating light which travels from the light emitting source to the at least one optical film via the optical plate;
wherein the light emitting source is received in the rear shell.

2. The backlight module of claim 1, wherein the rear module further comprises a reflective plate received in the rear shell for reflecting the light generated by the light emitting source toward the optical plate.

3. The backlight module of claim 2, wherein rear shell comprises a base plate and a sidewall extending from the base plate, the base plate and the sidewall cooperatively defining a chamber therebetween, the light emitting source, the reflective plate and the optical plate being received in the chamber, the light emitting source being located between the reflective plate and the base plate, the reflective plate being located between the light emitting source and the optical plate, the light emitting source having light emitting components extending through the reflective plate to be exposed from the reflective plate.

4. The backlight module of claim 3, wherein the light emitting components are light emitting diodes.

5. The backlight module of claim 4, wherein the optical plate is a diffusion plate.

6. The backlight module of claim 5, wherein the at least one optical film is selected from a group consisting of a prism film and a reflective polarization film.

7. The backlight module of claim 6, wherein the middle frame and the rear shell are mechanically connected together by having the middle frame mechanically connected with the sidewall of the rear shell.

8. The backlight module of claim 2, wherein the optical plate is a light guide.

9. The backlight module of claim 8, wherein the at one optical film is selected from a group consisting of a prism film and a reflective polarization film.

10. A liquid crystal display (LCD) device comprising:
a front module comprising a hollow middle frame and at least one optical film attached to the middle frame;
a rear module comprising a rear shell to which the middle frame is mechanically connected, an optical plate received in the rear shell and a light emitting source for generating light which travels from the light emitting source to the at least one optical film via the optical plate, the light emitting source being received in the rear shell;
a display panel; and
a front frame sandwiching the display panel between the front frame and the middle frame.

11. The LCD device of claim 10, wherein the rear module further comprises a reflective plate received in the rear shell for reflecting the light generated by the light emitting source toward the optical plate.

12. The LCD device of claim 11, wherein rear shell has a base plate and a sidewall extending from the base plate, the base plate and the sidewall cooperatively defining a chamber therebetween, the light emitting source, the reflective plate and the optical plate being received in the chamber, the light emitting source being located between the reflective plate and the base plate, the reflective plate being located between the light emitting source and the optical plate, the light emitting source having light emitting components extending through the reflective plate to be exposed from the reflective plate.

13. The LCD device of claim 12, wherein the light emitting components are light emitting diodes.

14. The LCD device of claim 13, wherein the optical plate is a diffusion plate.

15. The LCD device of claim 14, wherein the at least one optical film is selected from a group consisting of a prism film and a reflective polarization film.

16. The LCD device of claim 15, wherein the middle frame and the rear shell are mechanically connected together by having the middle frame mechanically connected with the sidewall of the rear shell.

17. The LCD device of claim 11, wherein the optical plate is a light guide.

18. The LCD device of claim 17, wherein the at one optical film is selected from a group consisting of a prism film and a reflective polarization film.
